(19) United States
(12) Patent Application Publication
(10) Pub. No.: US 2020/0001919 A1
(43) Pub. Date: Jan. 2, 2020

(54) HITCH ASSIST SYSTEM

(71) Applicant: Ford Global Technologies, LLC, Dearborn, MI (US)

(72) Inventors: Luke Niewiadomski, Hamtramck, MI (US); Chen Zhang, San Jose, CA (US); Theresa Lin, Berkeley, CA (US)

(21) Appl. No.: 16/020,243

(22) Filed: Jun. 27, 2018

(51) Int. Cl. B62D 15/02; B60D 1/36; B60R 1/00

(52) U.S. Cl. CPC B62D 15/025; G05D 1/0088; B60R 1/003; B60D 1/36

(57) ABSTRACT

A hitch assist system is provided herein. The hitch assist system includes a sensing system configured to detect a hitch assembly and a coupler. A controller is configured to generate commands for maneuvering the vehicle along a positioning path and a subsequent alignment path. The alignment path has one or more sequential corrections such that the hitch assembly is aligned with the coupler upon completion of the alignment path.

### FIELD OF THE INVENTION

The present disclosure generally relates to autonomous and semi-autonomous vehicle systems, and more particularly, to hitch assist systems that facilitate the hitching of a vehicle to a trailer.

### BACKGROUND OF THE INVENTION

The process of hitching a vehicle to a trailer can be difficult, especially to those lacking experience. Accordingly, there is a need for a system that simplifies the process by assisting a user in a simple yet intuitive manner.

### SUMMARY OF THE INVENTION

According to some aspects of the present disclosure, a hitch assist system is provided herein. The hitch assist system includes a sensing system configured to detect a hitch assembly and a coupler. A controller is configured to generate commands for maneuvering the vehicle along a positioning path and a subsequent alignment path. The alignment path has one or more sequential corrections such that the hitch assembly is aligned with the coupler upon completion of the alignment path.

According to some aspects of the present disclosure, a method of correcting misalignment between a vehicle hitch assembly and a coupler is provided herein. The method includes determining an offset of a hitch ball relative to said coupler. The method also includes calculating a first segment along an alignment path to align the hitch ball to said coupler. The method further includes maintaining a first constant steering angle. The method also includes maneuvering the vehicle a predefined distance along the first segment and stopping the vehicle. Lastly, the method includes recalculating the offset of the hitch ball relative to said coupler.

According to some aspects of the present disclosure, a hitch assist system is provided herein. The hitch assist system includes a sensing system configured to detect a hitch assembly and a coupler. A controller is configured to generate commands for maneuvering the vehicle along a positioning path and a subsequent alignment path. The alignment path has one or more sequential corrections. A brake control system is configured to stop the vehicle between the positioning path and the subsequent alignment path.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of a vehicle and a trailer, the vehicle being equipped with a hitch assist system, according to some examples;

FIG. 2 is a block diagram illustrating various components of the hitch assist system, according to some examples;

FIG. 3 is an overhead schematic view of the vehicle during a step of the alignment sequence with the trailer, according to some examples;

FIG. 4 is an overhead schematic view of the vehicle during a subsequent step of the alignment sequence with the trailer, according to some examples;

FIG. 5 is an overhead schematic view of the vehicle during a subsequent step of the alignment sequence with the trailer, according to some examples;

FIG. 6 is an overhead schematic view of the vehicle during a subsequent step of the alignment sequence with the trailer and showing the position of a hitch ball of the vehicle at an end of a derived alignment path, according to some examples;

FIG. 7 is a flowchart illustrating the steps of aligning the hitch ball to the coupler including a positioning path and an alignment path, according to some examples;

FIG. 8 is an overhead schematic view of the hitch ball offset from the coupler during a step of the alignment sequence with the trailer, according to some examples;

FIG. 9 is an overhead schematic view of the hitch ball offset from the coupler during a subsequent step of the alignment sequence with the trailer after a first correction, according to some examples;

FIG. 10 is an overhead schematic view of the hitch ball offset from the coupler during a subsequent step of the alignment sequence with the trailer after a second correction, according to some examples;

FIG. 11 is an overhead schematic view of the hitch ball during a subsequent step of the alignment sequence with the coupler and showing the end of a derived alignment path after a third correction, according to some examples;

FIG. 12 is an overhead schematic view of the hitch ball latitudinally and longitudinally offset from the coupler, according to some examples;

FIG. 13 is an overhead schematic view of the hitch ball offset from the coupler with a projected alignment path exemplarily illustrated thereon, according to some examples;

FIG. 14 is an overhead schematic view of the hitch ball offset from the coupler after a first correction along the alignment path, according to some examples;

FIG. 15 is an overhead schematic view of the hitch ball offset from the coupler after a second correction along the alignment path, according to some examples;

FIG. 16 is an overhead schematic view of the hitch ball offset from the coupler after a third correction along the alignment path, according to some examples;

FIG. 17 is an overhead schematic view of the hitch ball offset from the coupler after a fourth correction along the alignment path, according to some examples; and

FIG. 18 is a flowchart illustrating the steps of aligning the hitch ball to the coupler including a positioning path and an alignment path when the hitch ball is laterally offset from the coupler, according to some examples.

### DETAILED DESCRIPTION OF THE PREFERRED EXAMPLES

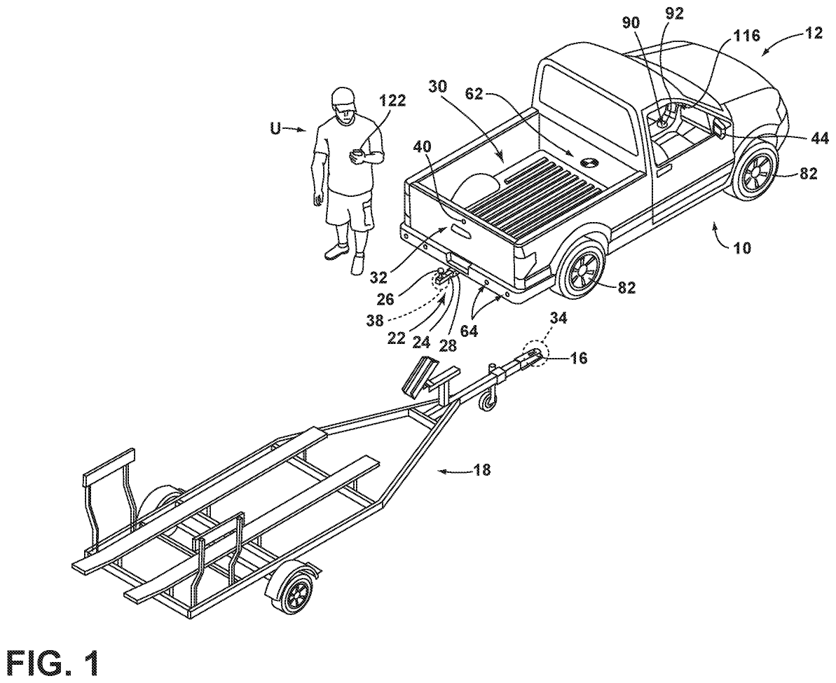

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a hitch assist system for a vehicle. The hitch assist system may include a sensing system configured to detect a hitch assembly and/or a coupler of a trailer. The hitch assist system further includes a controller configured to generate commands for maneuvering the vehicle along a positioning path and a subsequent alignment path, if desired and/or needed. The positioning path locates the hitch assembly proximate the coupler of the trailer. The alignment path may have one or more sequential corrections such that the hitch assembly is aligned with the coupler upon completion of the alignment path. The vehicle may be stopped between the two paths and/or between each correction to determine each sequential correction after completion of the previous motion.

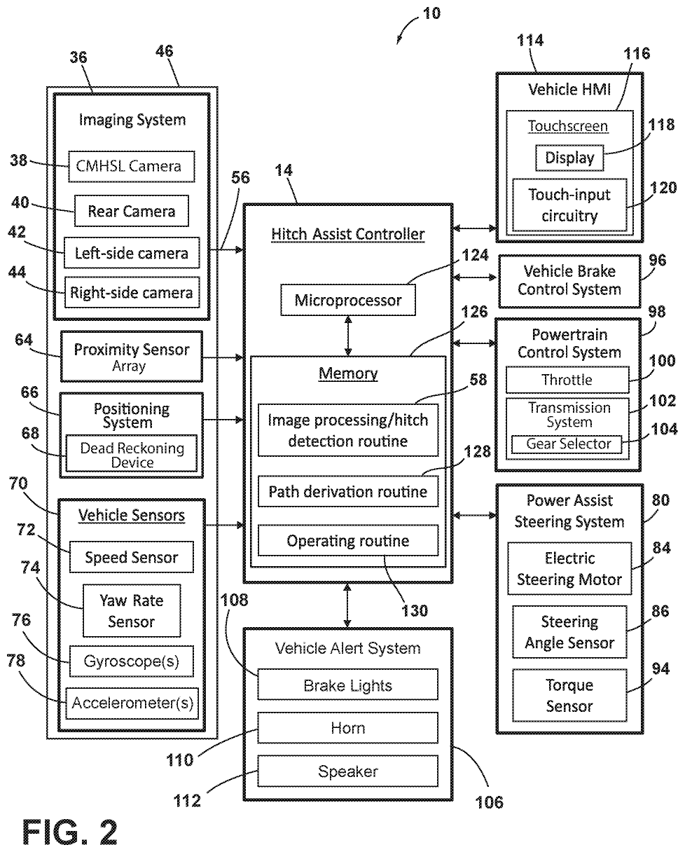

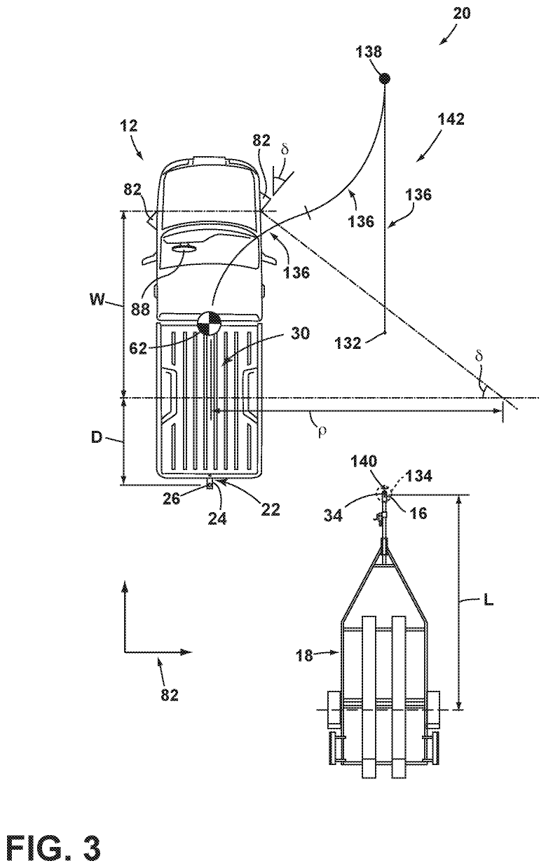

Referring to FIGS. 1 and 2, reference numeral 10 designates a hitch assistance system (also referred to as a “hitch assist” system) for a vehicle 12. In particular, the hitch assist system 10 includes a controller 14 acquiring position data of a coupler 16 of a trailer 18 and deriving a vehicle path 20 (FIG. 3) to align a hitch assembly 22 of the vehicle 12 with the coupler 16. In some examples, the hitch assembly 22 may include a ball mount 24 supporting a hitch ball 26. The hitch ball 26 may be fixed on the ball mount 24 that extends from the vehicle 12 and/or the hitch ball 26 may be fixed to a portion of the vehicle 12, such as a bumper of the vehicle 12. The ball mount 24 may couple with a receiver 28 that is fixed to the vehicle 12.

As shown in FIG. 1, the vehicle 12 is exemplarily embodied as a pickup truck having a truck bed 30 that is accessible via a rotatable tailgate 32. The hitch ball 26 may be received by a coupler 16 in the form of a coupler ball socket 34 that is provided at a terminal end portion of the coupler 16. The trailer 18 is exemplarily embodied as a single axle trailer from which the coupler 16 extends longitudinally. It will be appreciated that additional examples of the trailer 18 may alternatively couple with the vehicle 12 to provide a pivoting connection, such as by connecting with a fifth wheel connector. It is also contemplated that additional examples of the trailer 18 may include more than one axle and may have various shapes and sizes configured for different loads and items, such as a box trailer or a flatbed trailer without departing from the teachings provided herein.

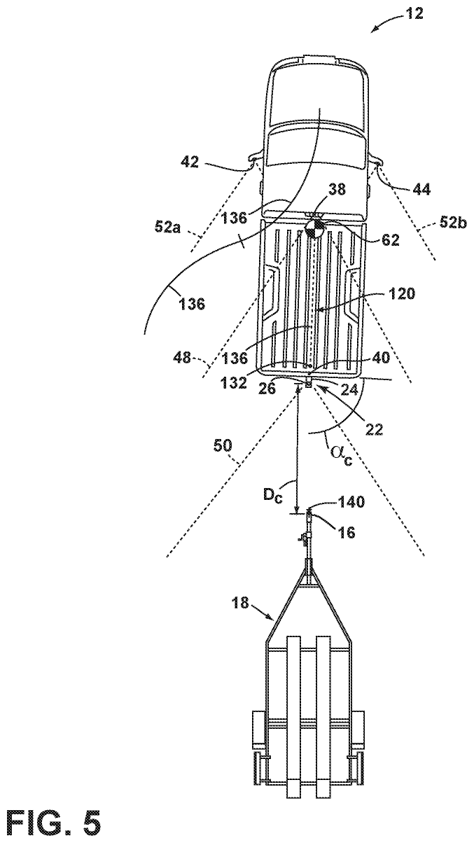

With respect to the general operation of the hitch assist system 10, as illustrated in FIG. 2, the hitch assist system 10 includes a sensing system 46 that includes various sensors and devices that obtain or otherwise provide vehicle status-related information. For example, in some instances, the sensing system 46 incorporates an imaging system 36 that includes one or more exterior imagers 38, 40, 42, 44, or any other vision-based device. The one or more imagers 38, 40, 42, 44 each include an area-type image sensor, such as a CCD or a CMOS image sensor, and image-capturing optics that capture an image of an imaging field of view (e.g., field of views 48, 50, 52a, 52b, FIG. 5) defined by the image-capturing optics. In some instances, the one or more imagers 38, 40, 42, 44 may derive an image patch from multiple image frames that may be shown on a display 118. In various examples, the hitch assist system 10 may include any one or more of a center high-mount stop light (CMHSL) imager 38, a rear imager 40, a left-side side-view imager 42, and/or a right-side side-view imager 44, although other arrangements including additional or alternative imagers are possible without departing from the scope of the present disclosure.

In some examples, the imaging system 36 can include the rear imager 40 alone or can be configured such that the hitch assist system 10 utilizes only the rear imager 40 in a vehicle 12 with the multiple exterior imagers 38, 40, 42, 44. In some instances, the various imagers 38, 40, 42, 44 included in the imaging system 36 can be positioned to generally overlap in their respective fields of view, which in the depicted arrangement of FIG. 5 includes fields of view 48, 50, 52a, 52b to correspond with the CMHSL imager 38, the rear imager 40, and the side-view imagers 42 and 44, respectively. In this manner, image data 56 from two or more of the imagers 38, 40, 42, 44 can be combined in an image processing routine 58, or in another dedicated image processor within the imaging system 36, into a single image or image patch. In an extension of such examples, the image data 56 can be used to derive stereoscopic image data 56 that can be used to reconstruct a three-dimensional scene of the area or areas within overlapped areas of the various fields of view 48, 50, 52a, 52b, including any objects (e.g., obstacles or the coupler 16) therein.

In some examples, the use of two images including the same object can be used to determine a location of the object relative to the two imagers 38, 40, 42, 44, given a known spatial relationship between the imagers 38, 40, 42, 44 through projective geometry of the imagers 38, 40, 42, 44. In this respect, the image processing routine 58 can use known programming and/or functionality to identify an object within the image data 56 from the various imagers 38, 40, 42, 44 within the imaging system 36. The image processing routine 58 can include information related to the positioning of any of the imagers 38, 40, 42, 44 present on the vehicle 12 or utilized by the hitch assist system 10, including relative to a center 62 (FIG. 1) of the vehicle 12. For example, the positions of the imagers 38, 40, 42, 44 relative to the center 62 of the vehicle 12 and/or to each other can be used for object positioning calculations and to result in object position data relative to the center 62 of the vehicle 12, for example, or other features of the vehicle 12, such as the hitch ball 26 (FIG. 1), with known positions relative to the center 62 of the vehicle 12.

With further reference to FIGS. 1 and 2, a proximity sensor 64 or an array thereof, and/or other vehicle sensors 70, may provide sensor signals that the controller 14 of the hitch assist system 10 processes with various routines to determine various objects proximate the vehicle 12, the trailer 18, and/or the coupler 16 of the trailer 18. The proximity sensor 64 may also be utilized to determine a height and position of the coupler 16. The proximity sensor 64 may be configured as any type of sensor, such as an ultrasonic sensor, a radio detection and ranging (RADAR) sensor, a sound navigation and ranging (SONAR) sensor, a light detection and ranging (LIDAR) sensor, a vision-based sensor, and/or any other type of sensor known in the art.

Referring still to FIGS. 1 and 2, a positioning system 66, which may include a dead reckoning device 68 or, in addition, or as an alternative, a global positioning system (GPS) that determines a coordinate location of the vehicle 12. For example, the dead reckoning device 68 can establish and track the coordinate location of the vehicle 12 within a localized coordinate system based at least on vehicle speed and/or steering angle δ (FIG. 3). The controller 14 may also be operably coupled with various vehicle sensors 70, such as a speed sensor 72 and a yaw rate sensor 74. Additionally, the controller 14 may communicate with one or more gyroscopes 76 and accelerometers 78 to measure the position, orientation, direction, and/or speed of the vehicle 12.

To enable autonomous or semi-autonomous control of the vehicle 12, the controller 14 of the hitch assist system 10 may be further configured to communicate with a variety of vehicle systems. According to some examples, the controller 14 of the hitch assist system 10 may control a power assist steering system 80 of the vehicle 12 to operate the steered road wheels 82 of the vehicle 12 while the vehicle 12 moves along a vehicle path 20. The power assist steering system 80 may be an electric power-assisted steering (EPAS) system that includes an electric steering motor 84 for turning the steered road wheels 82 to a steering angle δ based on a steering command generated by the controller 14, whereby the steering angle δ may be sensed by a steering angle sensor 86 of the power assist steering system 80 and provided to the controller 14. As described herein, the steering command may be provided for autonomously steering the vehicle 12 during a maneuver and may alternatively be provided manually via a rotational position (e.g., a steering wheel angle) of a steering wheel 88 (FIG. 3) or a steering input device 90, which may be provided to enable a driver to control or otherwise modify the desired curvature of the path 20 of vehicle 12. The steering input device 90 may be communicatively coupled to the controller 14 in a wired or wireless manner and provides the controller 14 with information defining the desired curvature of the path 20 of the vehicle 12. In response, the controller 14 processes the information and generates corresponding steering commands that are supplied to the power assist steering system 80 of the vehicle 12. In some examples, the steering input device 90 includes a rotatable knob 92 operable between a number of rotated positions that each provides an incremental change to the desired curvature of the path 20 of the vehicle 12.

In some examples, the steering wheel 88 of the vehicle 12 may be mechanically coupled with the steered road wheels 82 of the vehicle 12, such that the steering wheel 88 moves in concert with steered road wheels 82 via an internal torque, thereby preventing manual intervention with the steering wheel 88 during autonomous steering of the vehicle 12. In such instances, the power assist steering system 80 may include a torque sensor 94 that senses torque (e.g., gripping and/or turning) on the steering wheel 88 that is not expected from the autonomous control of the steering wheel 88 and therefore is indicative of manual intervention by the driver. In some examples, the external torque applied to the steering wheel 88 may serve as a signal to the controller 14 that the driver has taken manual control and for the hitch assist system 10 to discontinue autonomous steering functionality.

The controller 14 of the hitch assist system 10 may also communicate with a vehicle brake control system 96 of the vehicle 12 to receive vehicle speed information such as individual wheel speeds of the vehicle 12. Additionally or alternatively, vehicle speed information may be provided to the controller 14 by a powertrain control system 98 and/or the vehicle speed sensor 72, among other conceivable means. The powertrain control system 98 may include a throttle 100 and a transmission system 102. A gear selector 104 may be disposed within the transmission system 102 that controls the mode of operation of a vehicle transmission. In some examples, the controller 14 may provide braking commands to the vehicle brake control system 96, thereby allowing the hitch assist system 10 to regulate the speed of the vehicle 12 during a maneuver of the vehicle 12. It will be appreciated that the controller 14 may additionally or alternatively regulate the speed of the vehicle 12 via interaction with the powertrain control system 98.

Through interaction with the power assist steering system 80, the vehicle brake control system 96, and/or the powertrain control system 98 of the vehicle 12, the potential for unacceptable conditions can be reduced when the vehicle 12 is moving along the path 20. Examples of unacceptable conditions include, but are not limited to, a vehicle over-speed condition, sensor failure, and the like. In such circumstances, the driver may be unaware of the failure until the unacceptable backup condition is imminent or already happening. Therefore, it is disclosed herein that the controller 14 of the hitch assist system 10 can generate an alert signal corresponding to a notification of an actual, impending, and/or anticipated unacceptable backup condition, and prior to driver intervention, generate a countermeasure to prevent such an unacceptable backup condition.

According to some examples, the controller 14 may communicate with one or more devices, including a vehicle alert system 106, which may prompt visual, auditory, and tactile notifications and/or warnings. For instance, vehicle brake lights 108 and/or vehicle emergency flashers may provide a visual alert. A vehicle horn 110 and/or speaker 112 may provide an audible alert. Additionally, the controller 14 and/or vehicle alert system 106 may communicate with a human-machine interface (HMI) 114 of the vehicle 12. The HMI 114 may include a touchscreen 116 such as a navigation and/or entertainment display 118 mounted within a cockpit module, an instrument cluster, and/or any other location within the vehicle 12, which may be capable of displaying images 52 (FIG. 5), indicating the alert.

In some instances, the HMI 114 further includes an input device, which can be implemented by configuring the display 118 as a portion of the touchscreen 116 with circuitry 120 to receive an input corresponding with a location over the display 118. Other forms of input, including one or more joysticks, digital input pads, or the like can be used in place or in addition to touchscreen 116.

Further, the hitch assist system 10 may communicate via wired and/or wireless communication with some instances of the HMI 114 and/or with one or more handheld or portable devices 122 (FIG. 1). The network may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The portable device 122 may also include the display 118 for displaying one or more images and other information to a user U. For instance, the portable device 122 may display one or more images of the trailer 18 on the display 118 and may be further able to receive remote user inputs via touchscreen circuitry 120. In addition, the portable device 122 may provide feedback information, such as visual, audible, and tactile alerts. It will be appreciated that the portable device 122 may be any one of a variety of computing devices and may include a processor and memory. For example, the portable device 122 may be a cell phone, mobile communication device, key fob, wearable device (e.g., fitness band, watch, glasses, jewelry, wallet), apparel (e.g., a tee shirt, gloves, shoes or other accessories), personal digital assistant, headphones and/or other devices that include capabilities for wireless communications and/or any wired communications protocols.

The controller 14 is configured with a microprocessor 124 and/or other analog and/or digital circuitry for processing one or more logic routines stored in a memory 126. The logic routines may include one or more routines including the image processing/hitch detection routine 58, a path derivation routine 128, and an operating routine 130. Information from the imager 40 or other components of the sensing system 46 can be supplied to the controller 14 via a communication network of the vehicle 12, which can include a controller area network (CAN), a local interconnect network (LIN), or other protocols used in the automotive industry. It will be appreciated that the controller 14 may be a stand-alone dedicated controller or may be a shared controller integrated with the imager 40 or other component of the hitch assist system 10 in addition to any other conceivable onboard or off-board vehicle control systems.

The controller 14 may include any combination of software and/or processing circuitry suitable for controlling the various components of the hitch assist system 10 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. All such computing devices and environments are intended to fall within the meaning of the term “controller” or “processor” as used herein unless a different meaning is explicitly provided or otherwise clear from the context.

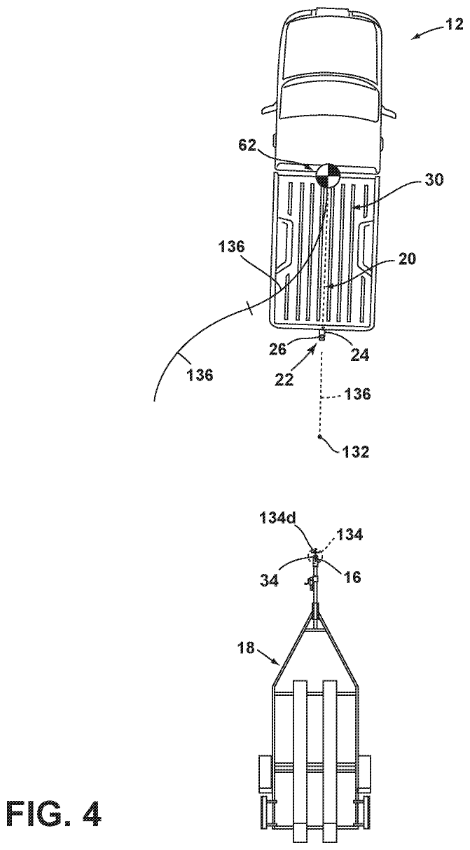

With further reference to FIGS. 2-6, the controller 14 may generate vehicle steering information and commands as a function of all or a portion of the information received. Thereafter, the vehicle steering information and commands may be provided to the power assist steering system 80 for effecting the steering of the vehicle 12 to achieve a commanded path 20 of travel for alignment with the coupler 16 of the trailer 18. It will further be appreciated that the image processing routine 58 may be carried out by a dedicated processor, for example, within a stand-alone imaging system 36 for the vehicle 12 that can output the results of its image processing to other components and systems of vehicle 12, including the microprocessor 124. Further, any system, computer, processor, or the like that completes image processing functionality, such as that described herein, may be referred to herein as an “image processor” regardless of other functionality it may also implement (including simultaneously with executing the image processing routine 58).

In some examples, the image processing routine 58 can be programmed or otherwise configured to locate the coupler 16 within the image data 56. In some instances, the image processing routine 58 can identify the coupler 16 within the image data 56 based on stored or otherwise known visual characteristics of the coupler 16 or hitches in general. In some instances, a marker in the form of a sticker or the like may be affixed with trailer 18 in a specified position relative to coupler 16 in a manner similar to that which is described in commonly assigned U.S. Pat. No. 9,102,271, entitled “TRAILER MONITORING SYSTEM AND METHOD,” the entire disclosure of which is incorporated by reference herein. In such examples, the image processing routine 58 may be programmed with identifying characteristics of the marker for location in the image data 56, as well as the positioning of the coupler 16 relative to such a marker so that the location 28 of the coupler 16 can be determined based on the marker location. Additionally or alternatively, the controller 14 may seek confirmation that the recognized coupler 16 is the one desired by the user U, via a prompt on the touchscreen 116 and/or the portable device 122. If the coupler 16 determination is not confirmed, further image processing may be provided, or user-adjustment of the position 134 of the coupler 16 may be facilitated, either using the touchscreen 116 or another input to allow the user to move the depicted position 134 of the coupler 16 on the touchscreen 116, which the controller 14 uses to adjust the determination of the position 134 of the coupler 16 with respect to the vehicle 12 based on the above-described use of the image data 56. Alternatively, the user can visually determine the position 134 of the coupler 16 within an image presented on HMI 114 and can provide a touch input in a manner similar to that which is described in co-pending, commonly-assigned U.S. patent application Ser. No. 15/583,014, filed May 1, 2017, and entitled “SYSTEM TO AUTOMATE HITCHING A TRAILER,” the entire disclosure of which is incorporated by reference herein. The image processing routine 58 can then correlate the location of the touch input with the coordinate system applied to the image 30.

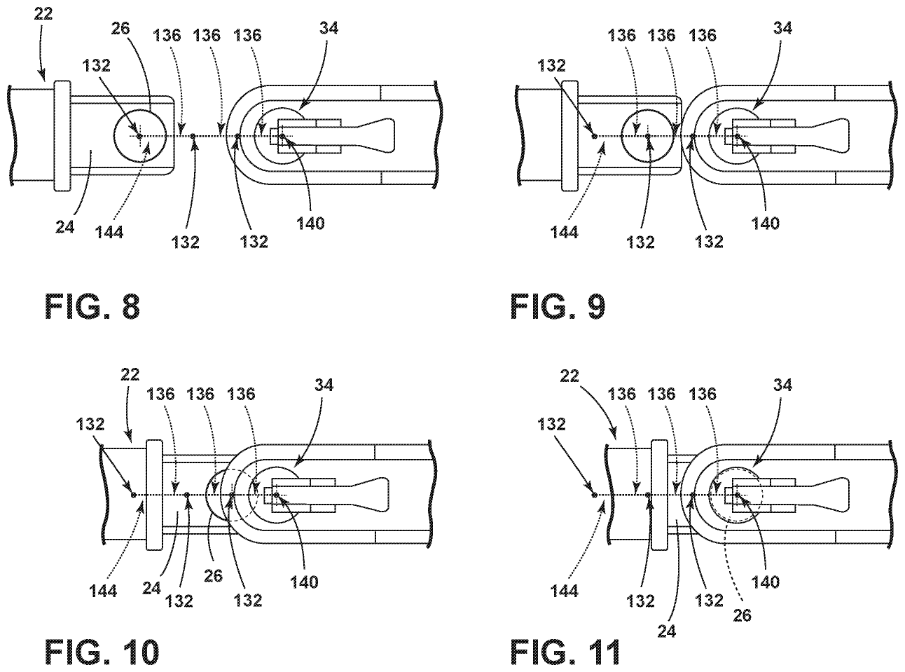

As shown in FIGS. 3-6, in some exemplary instances of the hitch assist system 10, the image processing routine 58 and operating routine 130 may be used in conjunction with each other to determine the path 20 along which the hitch assist system 10 can guide the vehicle 12 to align the hitch ball 26 and the coupler 16 of the trailer 18. As provided in more detail below, the path 20 may include a positioning path 142 and an alignment path 144 (FIGS. 8-11). Accordingly, the positioning path 142 may terminate at an initial endpoint 132 and the alignment path 144 may terminate at a final endpoint. In some circumstances, the initial and final endpoints 132, 140 may be the same location.

In the example shown, an initial position of the vehicle 12 relative to the trailer 18 may be such that the coupler 16 is in the field of view 52a of the side imager 42, with the vehicle 12 being positioned latitudinally from the trailer 18 but with the coupler 16 being almost longitudinally aligned with the hitch ball 26. In this manner, upon initiation of the hitch assist system 10, such as by user input on the touchscreen 116, for example, the image processing routine 58 can identify the coupler 16 within the image data 56 of the imager 42 and estimate the position 134 of the coupler 16 relative to the hitch ball 26 using the image data 56 in accordance with the examples discussed above or by other known means, including by receiving focal length information within image data 56 to determine a distance D_{c} to the coupler 16 and an angle α_{c} of offset between the coupler 16 and the longitudinal axis of vehicle 12. Once the positioning D_{c}, α_{c} of the coupler 16 has been determined and, optionally, confirmed by the user, the controller 14 can take control of at least the vehicle steering system 80 to control the movement of the vehicle 12 along the desired path 20 to align the vehicle hitch ball 26 with the coupler 16.

Continuing with reference to FIG. 3, the controller 14 (FIG. 2), having estimated the positioning D_{c}, α_{c} of the coupler 16, as discussed above, can, in some examples, execute the path derivation routine 128 to determine the vehicle path 20 to align the vehicle hitch ball 26 with the coupler 16. The controller 14 can store various characteristics of vehicle 12, including a wheelbase W, a distance D from the rear axle to the hitch ball 26, which is referred to herein as the drawbar length, as well as a maximum angle to which the steered wheels 82 can be turned δₘₐₓ. As shown, the wheelbase W and the current steering angle δ can be used to determine a corresponding turning radius p for the vehicle 12 according to the equation:

$$ρ = \frac{1}{W tan δ} , \qquad ( 1 )$$

in which the wheelbase W is fixed and the steering angle δ can be controlled by the controller 14 by communication with the steering system 80, as discussed above. In this manner, when the maximum steering angle δₘₐₓ is known, the smallest possible value for the turning radius ρₘᵢₙ is determined as:

$${ρ}_{min} = \frac{1}{W tan {δ}_{max}} . \qquad ( 2 )$$

The path derivation routine 128 can be programmed to derive the vehicle path 20 to align a known location of the vehicle hitch ball 26 with the estimated position 134 of the coupler 16 that takes into account the determined minimum turning radius ρₘᵢₙ, which may allow the path 20 to use the minimum amount of space and maneuvers. In this manner, the path derivation routine 128 can use the position of the vehicle 12, which can be based on the center 62 of the vehicle 12, a location along the rear axle, the location of the dead reckoning device 68, or another known location on the coordinate system, to determine both a lateral distance to the coupler 16 and a forward or rearward distance to coupler 16 and derive the path 20 that achieves lateral and/or forward-backward movement of the vehicle 12 within the limitations of the steering system 80. The derivation of the path 20 further takes into account the positioning of the hitch ball 26 relative to the tracked location of vehicle 12 (which may correspond with the center 62 of mass of the vehicle 12, the location of a GPS receiver, or another specified, known area) to determine the needed positioning of the vehicle 12 to align the hitch ball 26 with the coupler 16.

Once the desired path 20, including the initial endpoint 132, has been determined, the controller 14 may at least control the steering system 80 of the vehicle 12 with the powertrain control system 98 and the brake control system 96 (whether controlled by the driver or by the controller 14) controlling the speed (forward or rearward) of the vehicle 12. In this manner, the controller 14 can receive data regarding the position of the vehicle 12 during movement thereof from the positioning system 66 while controlling the steering system 80 to maintain the vehicle 12 along the path 20. The path 20, having been determined based on the vehicle 12 and the geometry of steering system 80, can adjust the steering angle δ, as dictated by the path 20, depending on the position of the vehicle 12 therealong. It is additionally noted that in some examples, the path 20 may comprise a progression of steering angle δ adjustments that are dependent on the tracked vehicle position. Moreover, in some instances, each correction may include a single steering angle δ adjustment during that correction.

As illustrated in FIG. 3, the initial positioning of the trailer 18 relative to the vehicle 12 may be such that forward movement of vehicle 12 is needed for the desired vehicle path 20, such as when the trailer 18 is latitudinally offset to the side of vehicle 12. In this manner, the path 20 may include various segments 136 of forward driving and/or rearward driving of the vehicle 12 separated by inflection points 138 at which the vehicle 12 transitions between forward and rearward movement. As used herein, “inflection points” are any point along the vehicle path in which a vehicle condition is changed. The vehicle conditions include, but are not limited to, a change in speed, a change in steering angle δ, a change in vehicle direction, and/or any other possible vehicle condition that may be adjusted. For example, if a vehicle speed is altered, an inflection point 138 may be at the location where the speed was altered. In some examples, the path derivation routine 128 can be configured to include a straight backing segment 136 for a defined distance before reaching the point at which the hitch ball 26 is aligned with the position 134 of the coupler 16. The remaining segments 136 can be determined to achieve the lateral and forward/backward movement within the smallest area possible and/or with the lowest number of overall segments 136 or inflection points 138. In the illustrated example of FIG. 3, the path 20 can include two segments 136 that collectively traverse the lateral movement of the vehicle 12, while providing a segment 136 of straight, rearward backing to bring the hitch ball 26 into an offset position 134 of the coupler 16, one of which includes forward driving with a maximum steering angle δₘₐₓ in the rightward-turning direction and the other including forward driving with a maximum steering angle δₘₐₓ in the leftward-turning direction. Subsequently, a single inflection point 138 is included in which the vehicle 12 transitions from forward driving to rearward driving followed by the previously-mentioned straight rearward backing segment 136. It is noted that variations in the depicted path 20 may be used, including a variation with a single forward-driving segment 136 at a rightward steering angle δ less than the maximum steering angle δₘₐₓ, followed by an inflection point 138 and a rearward driving segment 136 at a maximum leftward steering angle δₘₐₓ with a shorter straight backing segment 136, with still further paths 20 being possible.

In some instances, the hitch assist system 10 may be configured to operate with the vehicle 12 in reverse only, in which case the hitch assist system 10 can prompt the driver to drive vehicle 12, as needed, to position the trailer 18 in a designated area relative to the vehicle 12, including to the rear thereof so that path derivation routine 128 can determine a vehicle path 20 that includes rearward driving. Such instructions can further prompt the driver to position the vehicle 12 relative to the trailer 18 to compensate for other limitations of the hitch assist system 10, including a particular distance for identification of the coupler 16, a minimum offset angle α_{c}, or the like. It is further noted that the estimates for the positioning D_{c}, α_{c} of the coupler 16 may become more accurate as the vehicle 12 traverses the path 20, including to position the vehicle 12 in front of the trailer 18 and as the vehicle 12 approaches the coupler 16. Accordingly, such estimates can be derived and used to update the path derivation routine 128, if desired, in the determination of the adjusted initial endpoint 132 for the path 20.

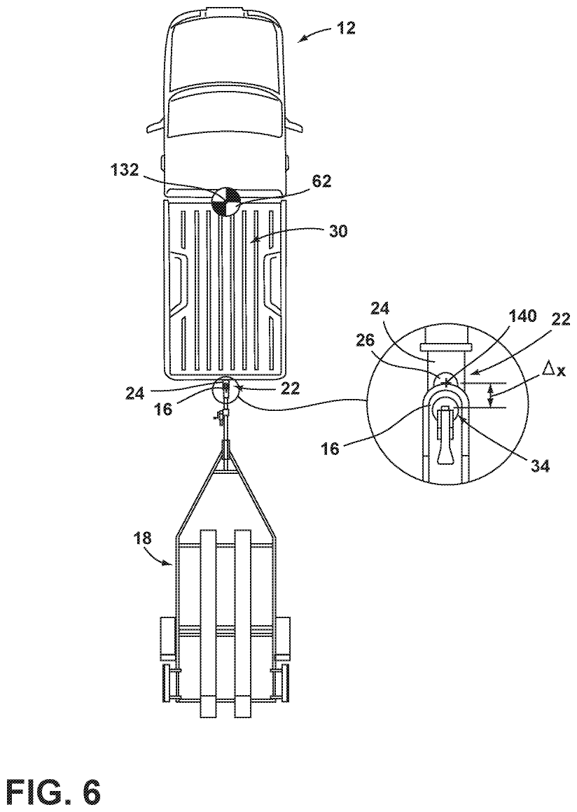

Referring to FIGS. 5 and 6, a strategy for determining an initial endpoint 132 for the vehicle path 20 that places hitch ball 26 in a projected position for alignment with the coupler 16 given the vertical component of the position 134 of the coupler 16 involves calculating the actual or an approximate trajectory for movement of the coupler 16 while lowering the coupler 16 on to the hitch ball 26. The initial endpoint 132 is then derived, as discussed above or otherwise, to place hitch ball 26 at the desired location 140 on that trajectory. In effect, such a scheme is implemented by determining the difference between the height of the coupler 16 and the height of the hitch ball 26, which represents the vertical distance by which coupler 16 will be lowered to engage with hitch ball 26. The determined trajectory is then used to relate the vertical distance with a corresponding horizontal distance Δx of coupler 16 movement in the driving direction that results from the vertical distance. This horizontal distance Δx can be input into the path derivation routine 128 as the desired initial endpoint 132 thereof or can be applied as an offset to the initial endpoint 132 derived from the initially determined position 134 of the coupler 16 when the path 20 ends with the straight-backing segment 136, as illustrated in FIG. 3. As provided herein, once the projected initial endpoint 132 has been reached, or the vehicle 12 is proximate to the initial endpoint 132, the positioning path 142 (FIG. 3) may be complete. If the initial endpoint 132 is offset from the final endpoint 140, the alignment path 144 may begin and move the vehicle 12 to the final endpoint 140.

Referring again to FIGS. 5 and 6, the operating routine 130 may continue to guide the vehicle 12 until the hitch ball 26 is in the desired final endpoint 140 relative to the coupler 16 for the coupler 16 to engage with the hitch ball 26 when the coupler 16 is lowered into alignment and/or engagement therewith. In the examples discussed above, the image processing routine 58 monitors the positioning D_{c}, αc of the coupler 16 during execution of the operating routine 130, including as the coupler 16 comes into clearer view of the rear imager 40 with continued movement of the vehicle 12 along the path 20. As discussed above, the position of the vehicle 12 can also be monitored by the dead reckoning device 68 with the position 134 of the coupler 16 being updated and fed into the path derivation routine 128 in case the path 20 and or the initial endpoint 132 can be refined or should be updated (due to, for example, improved coupler height H_{c}, distance D_{c}, or offset angle α_{c} information due to closer resolution or additional image data 56), including as the vehicle 12 moves closer to the trailer 18. In some instances, the coupler 16 can be assumed static such that the position of the vehicle 12 can be tracked by continuing to track the coupler 16 to remove the need for use of the dead reckoning device 68. In a similar manner, a modified variation of the operating routine 130 can progress through a predetermined sequence of maneuvers involving steering of the vehicle 12 at or below a maximum steering angle δₘₐₓ, while tracking the position D_{c}, α_{c} of the coupler 16 to converge the known relative position of the hitch ball 26 to the desired final endpoint 140 thereof relative to the tracked position 134 of the coupler 16.

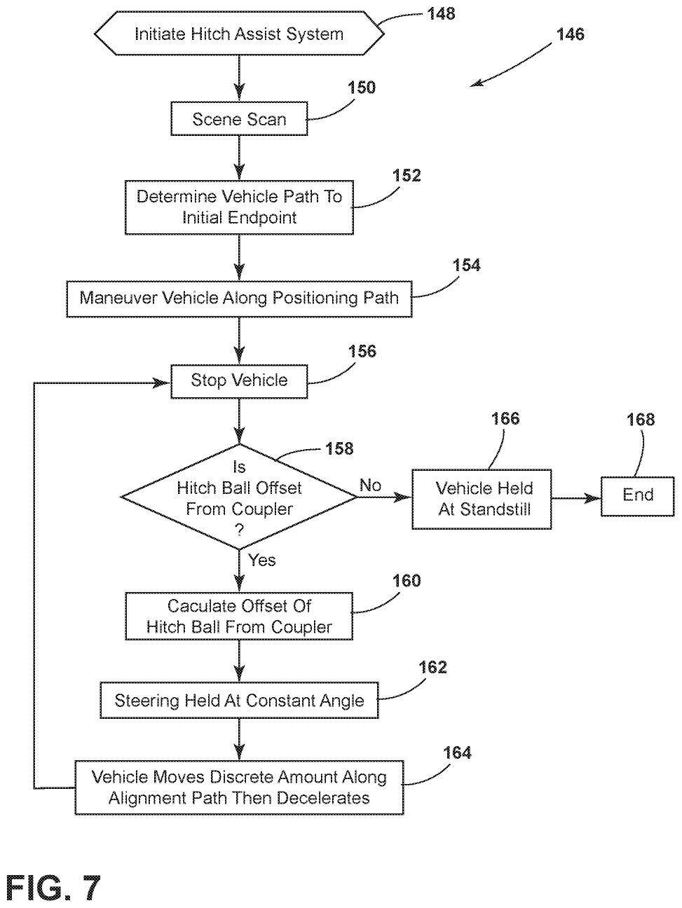

Referring to FIGS. 7-11, as provided herein, the vehicle path 20 may include a positioning path 142 (FIG. 3) and a subsequent alignment path 144. The positioning path 142 may locate the vehicle 12 proximate the initial endpoint 132, which may be a predefined offset vehicle forwardly of the coupler 16 to mitigate misalignment issues due to error from a wide range of variants. For example, various conditions of the brake system, various types of round surfaces, variances in vehicle weight, various tire designs, a level of wear of the tires, a gradient of the terrain, software latency, network interference, etc. may affect the precision of the vehicle 12 to reach the initial endpoint 132. Additionally, because a wide range of variants may lead to the vehicle 12 backing past a desired alignment position, the offset may assist in preventing unwanted conditions such as overshooting the coupler 16 and possibly leading to contact between the trailer 18 and the vehicle 12. To increase the precision of the hitch assembly 22 in relation to the coupler 16, the alignment path 144 may include one or more sequential, and possibly discrete, corrections. During each correction, the vehicle 12 may accelerate and decelerate. In some instances, the deceleration may continue until the vehicle 12 is stopped. Sequential corrections may continue until an alignment is achieved or the system is paused automatically or by the user U. It will be appreciated that in some circumstances corrections may not be needed. For example, when a correction would move the vehicle 12 to a location further from the final endpoint 140 than the current position of the vehicle 12 at the initial endpoint 132, a correction may not be performed.

With further reference to FIGS. 7-11, upon completion of the positioning path 142 (FIG. 3), the vehicle 12 may come to a stop. While the vehicle 12 is stopped, the hitch assist system 10 may generate the alignment path 144 that includes one or more sequential corrections. Due to the stopped vehicle condition, the precision of the positioning of the hitch assembly 22 relative to the coupler 16 may be increased since the performance of a correction is beginning from vehicle standstill, or a slow speed in some cases. Further, during each sequential correction, the vehicle 12 may travel a minimal distance that may be less than the distance between the current vehicle 12 stop point and the coupler 16. For example, in some instances, the vehicle road wheels 82 may rotate less than about one full rotation, less than about a half rotation, less than about a quarter rotation, and/or any other amount. It will be appreciated, however, that more than one rotation of the tires may occur during each correction in other examples. The small distance of each correction minimizes the possibility of error, or error stack up, during that correction. For example, if a decline gradient of the ground surface causes a stopping distance increase (e.g., +10%), the stopping distance increase percent for any of the segments 136 illustrated in FIG. 6 are longer when compared to a correction distance as illustrated in FIG. 8.

With further reference to FIG. 7, a method 146 of aligning the hitch assembly 22 with the coupler 16 in a longitudinal direction is shown. In particular, in step 148, the hitch assist system 10 is initiated. In some examples, the hitch assist system 10 can be initiated at any point when the coupler 16 is in the field of view 48, 50, 52a, 52b of at least one imager 38, 40, 42, 44 within imaging system 36. Accordingly, once the hitch assist system 10 is initiated, the controller 14 can use imaging system 36 to scan the viewable scene using any or all available imagers 38, 40, 42, 44 at step 150. The scene scan, at step 150, can create the image patch that may be used to then identify the coupler 16 and, optionally, the associated trailer 18. At step 152, the hitch assist system 10 determines an initial endpoint 132 of the vehicle path 20 that places the hitch ball 26 and the coupler 16 proximate one another.

At step 152, the controller 14 uses the path derivation routine 128 to determine the path 20 to align the vehicle 12 with the initial endpoint 132. Once the path 20 has been derived, the hitch assist system 10 can ask the user U to relinquish control of at least the steering wheel 88 of vehicle 12 (and, optionally, the throttle 100 and brake control system 96, in various implementations of the hitch assist system 10 wherein the controller 14 assumes control of the powertrain control system 98 and the brake control system 96 during execution of the operating routine 130) while the vehicle 12 is maneuvered along the positioning path 142 (FIG. 3). When it has been confirmed that user U is not attempting to control steering system 80 (for example, using the torque sensor 94), the controller 14 begins to move vehicle 12 along the determined path 20, at step 154. Furthermore, the hitch assist system 10 may determine if the transmission system 102 is in the correct gear and may shift to the desired gear or prompt the user U to shift to the desired gear. The hitch assist system 10 may then control the steering system 80 to maintain the vehicle 12 along the path 20 as either the user U or the controller 14 controls the speed of vehicle 12 using the powertrain control system 98 and the braking control system 96. As discussed herein, the controller 14 or the user U can control at least the steering system 80, while tracking the position 134 of the coupler 16 until the vehicle 12 reaches the initial endpoint 132, wherein the vehicle hitch ball 26 reaches the desired final endpoint 140 for the desired alignment with the coupler 16. At the initial endpoint 132, the hitch ball 26 may be separated from the coupler 16. The initial endpoint 132 may be an estimation of a real point along the ground plane. It is contemplated that the maneuvering of the vehicle 12 may occur manually, semi-autonomously, or autonomously. In semi-autonomous or autonomous examples of the hitch assist system 10, the controller 14 generates commands provided to the vehicle brake control system 96, the powertrain control system 98, and/or the power assist steering system 80 to maneuver the vehicle 12 toward the trailer 18 so that the hitch assembly 22 arrives at the initial endpoint 132. In semi-autonomous examples, the driver of the vehicle 12 may be required to apply gas and/or apply the brakes while the controller 14 steers the vehicle 12. In yet other examples, the user U may move the vehicle 12 to the desired endpoint.

At step 156, the hitch assist system 10 brings the vehicle 12 to a stop at the initial endpoint 132. The amount of distance between the hitch ball 26 and the final endpoint 140 may be a constant value that may ensure the vehicle 12 does not overshoot, or pass, the final endpoint 140 under all expected conditions. For example, the hitch assist system 10 may determine a maximum vehicle overshoot distance and separate the initial and final endpoints 132, 140 by that distance.

Once the vehicle 12 comes to a stop, at step 156, the hitch assist system 10 determines whether the hitch assembly 22 is offset in a longitudinal direction and/or a latitudinal direction for the coupler 16 at step 158. A longitudinal offset is an offset between the hitch assembly 22 and the coupler 16 in a vehicle heading direction, which may be in a vehicle forward and/or a vehicle rearward direction. A latitudinal offset is an offset between the hitch assembly 22 and the coupler 16 in which the current steering angle δ of the vehicle 12 needs to be changed to correct any misalignment issues between the hitch assembly 22 and the coupler 16.

At step 160, the offset between the hitch ball 26 and the coupler 16 is calculated. In instances where the offset between the hitch assembly 22 and the coupler 16 is in a longitudinal direction before the longitudinal motion is restarted, the steering angle δ is held at a constant value at step 162, which may be dictated by the controller 14 in response to the alignment path 144. In some examples, the steering angle δ may be held at a constant angle for the remainder of the corrections (steps 160-164). In alternate examples, the steering angle δ may be changed between corrections (steps 160-164) in order to improve alignment accuracy.

At step 164, the hitch assist system 10 performs a correction to advance the vehicle 12 towards the final endpoint 140. Each correction is a discrete movement, which may be of minimal repeatable distance. During the corrections, the hitch assist system 10 may control the powertrain control system 98 and/or the brake control system 96 to move the vehicle 12 in a discrete increment or predefined distance based on a scheduled brake pattern. The discretized movement may minimize error due to sensing and control delay that may occur while the vehicle 12 is in motion. In addition, the hitch assist system 10 may compare the actual movement distance after the correction with the predicted distance. In response to the comparison, the hitch assist system 10 adapts the brake parameters and prescheduled brake pattern before the next correction is performed to achieve the desired movement distances. The predetermined amount of time between corrections may be sufficient to collect any data for path 20 and correction calculations to be performed. However, in some examples, the data may be collected while one or more of the corrections is performed such that the corrections may be performed sequentially with no time delay therebetween. Moreover, in some instances, a predetermined brake profile may be employed for each correction, without any adjustment of parameters between corrections, such that the corrections can be initiated sequentially without delay therebetween.

Once a correction is performed at steps 160-164, the vehicle 12 returns to a stationary position at step 156 for a predetermined amount of time to allow for calculations and adjustments before the next correction, if needed and/or desired. If an additional correction is to be performed, while the vehicle 12 is stationary, a new endpoint position is accurately determined by the hitch assist system 10.

In some instances, the correction may occur if the offset between the hitch assembly 22 and the coupler 16 is greater than one-half of the distance of a correction while the vehicle 12 is in a stationary position. Accordingly, the overall hitch assist system 10 accuracy may also be improved to a value equal to the length of one-half of a distance of a correction and one-half of a correction distance variation. It will be appreciated that one-half distance of a correction and the correction distance variation are used because the vehicle 12 is stopped between corrections allowing for a dynamic decision for whether or not to perform another correction.

Once the system determines that a final endpoint 140 has been reached, wherein the coupler 16 may be engaged with the hitch ball 26, at step 166, the hitch assist system 10 may maintain the vehicle 12 in a substantially fixed position since idle torque from the engine or roll from terrain slope would lead to a misalignment with the positioning. The vehicle 12 may be maintained in a substantially fixed position through the application of continuous service brake torque, an automatic shifting over the gear shifter to park, an automatic engagement of a vehicle parking brake, HMI instructions to the user to perform any of the above steps before the service brakes are automatically released, and/or through any other method at which point the operating routing 146 may end at step 168.

Referring to FIGS. 8-11, as provided herein, the vehicle 12 may move along the alignment path 144 through discrete movements. For example, as illustrated in FIG. 8, the vehicle 12 may conclude the positioning path 142 (FIG. 3) at the initial endpoint 132 with the hitch ball 26 longitudinally offset from the coupler 16 by coming to a stop. While stopped, the controller 14 may calculate the offset distance between the hitch ball 26 and the coupler 16 and generate an alignment path 144. The vehicle 12 may move along a first segment 136 of the alignment path 144 during a first correction, as illustrated in FIG. 9 and stop at an inflection point 138 (FIG. 3) in which the offset between the hitch ball 26 and the coupler 16 is recalculated. Based on the updated calculations, the controller 14 may determine whether to keep moving along the same alignment path 144 or to define a new alignment path 144 upon which to move the vehicle 12 for a second correction, as illustrated in FIG. 10. Once the vehicle 12 reaches the end of the second correction at another inflection point 138, the vehicle 12 may again come to a stop, and controller 14 may determine whether to keep moving along the same alignment path 144 or to define a new alignment path 144 upon which to move the vehicle for a second correction. The vehicle may then move along the alignment path 144 for a third correction, as illustrated in FIG. 11, which places the hitch ball 26 and coupler 16 in an aligned position. The hitch assist system 10 may deem the hitch ball 26 and the coupler 16 to be in an aligned position, which ends the alignment path 144, and hitch assist process.

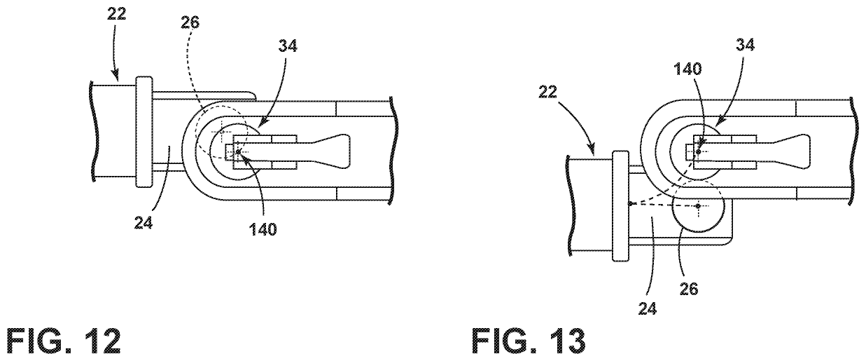

Referring to FIG. 12, in some examples, the hitch assembly 22 may be latitudinally offset from the coupler 16 in addition to or in lieu of a longitudinal offset, which may be overcome with an additional correction with a fixed steering angle δ and/or movement of the vehicle 12. In such instances, the controller 14 may employ predictive positioning for the endpoint of the next correction that accounts for offsets of the vehicle 12 relative the coupler 16 in the x-direction and/or the y-direction. To determine whether an additional correction would move the hitch assembly 22 closer to the coupler 16, the controller 14 may use the known relative hitch ball 26 position to the target in the xy-plane combined with the estimated value for the length of a single correction, the current vehicle heading direction, and the current fixed steering angle δ. Once this prediction is made, a distance d′ between the hitch ball 26 and the coupler 16 is calculated and compared against the current distance d between the hitch ball 26 and the coupler 16. If |d′|<|d|, another correction may be performed. If |d′|≥|d|, another correction may not move the hitch assembly 22 closer to the positioning and thus may not be performed.

Referring to FIGS. 13-17, in some instances, the steering angle δ may be adjusted before one or more of the corrections to further align the hitch assembly 22 to the coupler 16. It will be appreciated, however, that the steering angle δ may be adjusted during any of the corrections without departing from the scope of the present disclosure. In addition to variances in steering angle δ, the vehicle 12 may move in a first direction (e.g., forward) during a first correction and in a second direction (e.g., rearward) in a subsequent correction. Accordingly, the adjustment phase may include one or more segments 136, as described herein. Each segment 136 may be a discrete movement wherein data is collected therebetween for recalculating the next correction at an inflection point 138.

As illustrated in FIGS. 13-17, the initial endpoint 132 may lead to the hitch ball 26 being latitudinally and/or longitudinally offset from the coupler 16. In such instances, the alignment process may include a plurality of corrections to better position the hitch ball 26 in alignment with the coupler 16. For example, to better align the hitch ball 26 and the coupler 16 illustrated in FIG. 13, four corrections may be performed. However, it will be appreciated that any number of corrections may be performed without departing from the scope of the present disclosure.

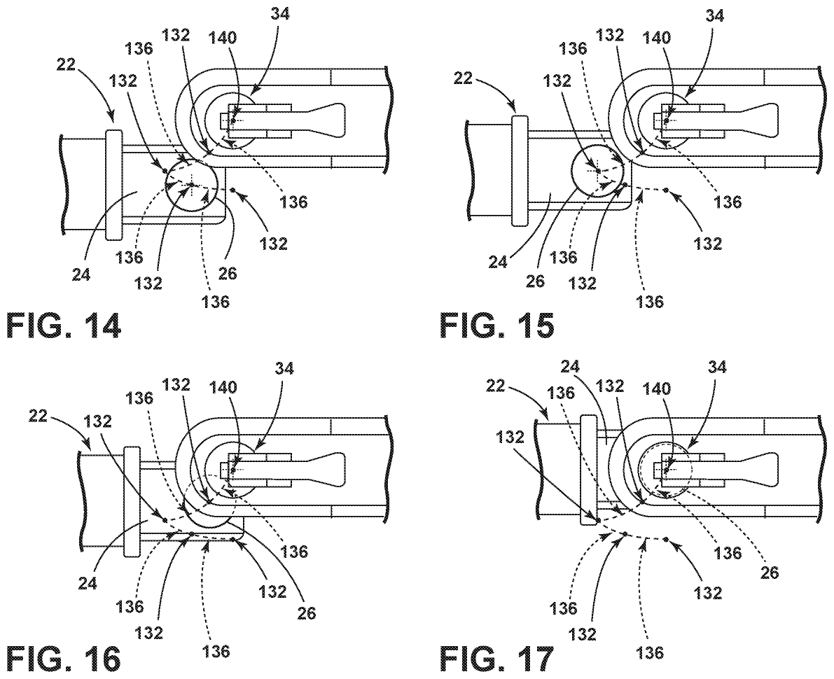

During a first correction of the alignment process, as exemplarily illustrated in FIG. 14, the steering angle δ may be fixed and the vehicle 12 may move in a vehicle forward direction for a predetermined distance before returning to a stopped position. During a second correction of the alignment process, as exemplarily illustrated in FIG. 15, the steering angle δ may be fixed at a common or varied angle from that of the first correction and the vehicle 12 may move again in a vehicle forward direction until the vehicle 12 reaches an inflection point 138, at which point the vehicle 12 returns to a stopped position. Next, during a third correction of the alignment process, as exemplarily illustrated in FIG. 16, the steering angle δ may be fixed at a common or varied angle from that of the first correction and/or the second correction and the vehicle 12 may move in a vehicle rearward direction for a predetermined distance before returning to a stopped position. Lastly, during a fourth correction of the alignment process, as exemplarily illustrated in FIG. 17, the steering angle δ may be fixed at a common or varied angle from that of the first correction, the second correction, and/or the third correction and the vehicle 12 may move in a vehicle rearward direction for a predetermined distance before returning to a stopped position. As provided herein, the offset distance between the hitch ball 26 and the coupler 16 may be recalculated between the discrete movements of each segment 136 or correction, which may allow for more precise alignment between the hitch ball 26 and the coupler 16. In the example illustrated in FIGS. 13-17, the hitch ball 26 and the coupler 16 are substantially aligned after the fourth correction. Accordingly, after the fourth correction, the vehicle 12 is maintained in a substantially fixed position through the application of continuous service brake torque, an automatic shifting over the gear shifter to park, an automatic engagement of a vehicle parking brake, HMI instructions to the user to perform any of the above steps before the service brakes are automatically released, and/or through any other method such that the coupler 16 may be coupled with the hitch assembly 22.

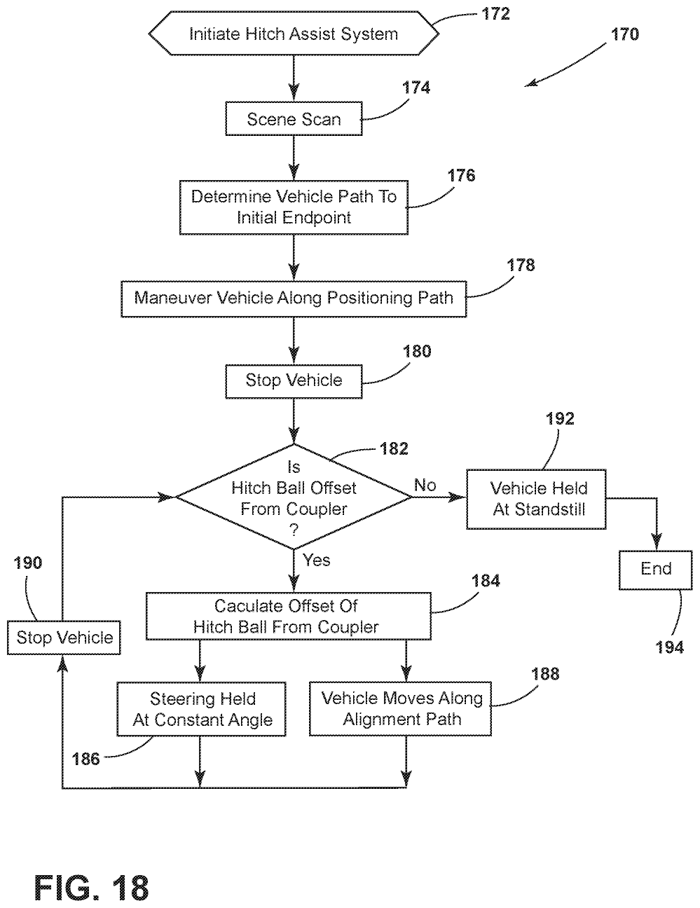

Referring to FIG. 18, a method 170 of aligning the hitch assembly 22 with the coupler 16 in a longitudinal and a latitudinal direction is exemplarily embodied. In particular, in step 172, the hitch assist system 10 is initiated. Once the hitch assist system 10 is initiated, the controller 14 can use the sensing system 46 of the vehicle 12, which may include using any or all available imagers 38, 40, 42, 44 at step 174. The scene scan, at step 174, can create the image patch that may be used to then identify the coupler 16 and, optionally, the associated trailer 18. At step 176, the hitch assist system 10 determines an initial endpoint 132 of the vehicle path 20 that places the hitch ball 26 and the coupler 16 proximate one another.

At step 176, the controller 14 uses the path derivation routine 128 to determine the path 20 to align the vehicle 12 with the initial endpoint 132. Once the path 20 has been derived, the hitch assist system 10 can ask the user U to relinquish control of at least the steering wheel 88 of vehicle 12 (and, optionally, the throttle 100 and brake control system 96, in various implementations of the hitch assist system 10 wherein the controller 14 assumes control of the powertrain control system 98 and the brake control system 96 during execution of the operating routine 130) while the vehicle 12 is maneuvered along the positioning path 142 (FIG. 3). When it has been confirmed that user U is not attempting to control steering system 80 (for example, using the torque sensor 94), the controller 14 begins to move vehicle 12 along the determined path 20, at step 178. Furthermore, the hitch assist system 10 may determine if the transmission system 102 is in the correct gear and may shift to the desired gear or prompt the user U to shift to the desired gear. The hitch assist system 10 may then control the steering system 80 to maintain the vehicle 12 along the path 20 as either the user U or the controller 14 controls the speed of vehicle 12 using the powertrain control system 98 and the braking control system 96. As discussed herein, the controller 14 or the user U can control at least the steering system 80, while tracking the position of the coupler 16 until the vehicle 12 reaches the initial endpoint 132, wherein the vehicle hitch ball 26 reaches the desired final endpoint 140 for the desired alignment with the coupler 16. At the initial endpoint 132, the hitch ball 26 may be separated from the coupler 16. It is contemplated that the maneuvering of the vehicle 12 may occur manually, semi-autonomously, or autonomously. In semi-autonomous or autonomous examples of the hitch assist system 10, the controller 14 generates commands provided to the vehicle brake control system 96, the powertrain control system 98, and/or the power assist steering system 80 to maneuver the vehicle 12 toward the trailer 18 so that the hitch assembly 22 arrives at the initial endpoint 132. In semi-autonomous examples, the driver of the vehicle 12 may be required to apply gas and/or apply the brakes while the controller 14 steers the vehicle 12. In yet other examples, the user U may move the vehicle 12 to the desired endpoint.

At step 180, the vehicle 12 may be stopped once the vehicle 12 is proximate the initial endpoint 132. At step 182, the hitch assist system 10 analyzes position data of the hitch ball 26 and the coupler 16, which is perceived via inputs from the vehicle sensing system 46 (e.g., the rear imager 40 in conjunction with image processing algorithms, which determine the position of each item, proximity sensors 64, etc.). The difference in position may be defined as the alignment error. The alignment error may be utilized in conjunction with the position data to determine an amount and direction of offset between the hitch ball 26 and the coupler 16.

At step 184, the amount and direction of offset are calculated by the hitch assist system 10 and the hitch assist system 10 may proceed to an alignment process in which an alignment path 144 is determined that includes one or more corrections. The corrections move the vehicle 12 a minimal amount that may be less than the offset distance between the hitch ball 26 and the coupler 16. As provided herein, the distance traveled by the vehicle 12 during each correction may be small, discrete, and/or repeatable.

In some instances, before performing each correction, the controller 14 may define the steering angle δ (which may be the maximum steering of the vehicle 12) and steering direction for that correction, at step 186. Thus, the hitch assist system 10 controls steering to account for lateral misalignment. The steering may be held at a fixed position, as determined by the alignment path 144, during the movement of the vehicle 12 while performing each correction. It will be appreciated that in some instances, the steering angle δ may be varied during a correction without departing from the scope of the present disclosure. Moreover, the steering angle δ can be adjusted between each correction.

At step 188, which may be performed contemporaneously with step 186, the hitch assist system 10 controls the powertrain system 98 and/or the brake control system 96 during the discrete correction based on a scheduled brake pattern. As provided herein, in some instance, the next correction is performed after the finish of the previous correction and the new position is confirmed by the sensing system 46.

Once a correction is performed at steps 182-188, the vehicle 12 returns to a stationary position, at step 190, for a predetermined amount of time to allow for calculations and adjustments before the next correction is performed, if needed and/or desired.

The routine may return to step 170, where the hitch assist system 10 determines if further corrections (steps 182-188) may move the hitch ball 26 to a position closer to the coupler 16. If an additional correction (steps 182-188) is to be performed, while the vehicle 12 is stationary, a new endpoint position is determined by the hitch assist system 10. The discretized movement may minimize error due to sensing and control delay that may occur while the vehicle 12 is in motion. In addition, the hitch assist system 10 may compare the actual movement distance during step 188 with a predicted distance. In response to the comparison, the hitch assist system 10 may adapt the brake parameters and prescheduled brake pattern before the next correction is performed to achieve the desired movement distances. The predetermined amount of time between corrections may be sufficient to collect any data for path 20 and correction calculations to be performed. However, in some examples, the data may be collected while one or more of the corrections is performed such that the corrections may be performed sequentially with no time delay therebetween. Moreover, in some instances, a predetermined brake profile may be employed for each correction, without any adjustment of parameters between corrections, such that the corrections can be initiated sequentially without delay therebetween.

Once the system determines that the endpoint has been reached, at step 192, the hitch assist system 10 may maintain the vehicle 12 in a substantially fixed position since idle torque from the engine or roll from terrain slope would almost immediately lead to a misalignment with the positioning. The vehicle 12 may be maintained in a substantially fixed position through the application of continuous service brake torque, an automatic shifting over the gear shifter to park, an automatic engagement of a vehicle parking brake, HMI instructions to the user to perform any of the above steps before the service brakes are automatically released, and/or through any other method. Once the coupler 16 is aligned with the hitch ball 26, the routine 170 may terminate at step 194.

A variety of advantages may be derived from the use of the present disclosure. For example, use of the disclosed hitch assist system provides a system for calculating dynamic adaptation of correction brake system parameters to reduce correction-to-correction variation and therefore increase the overall hitch assist system accuracy. A scheduled brake pattern is implemented to perform a correction and is adaptable if the correction distance is measured to be outside of a predetermined range by the vehicle tracking system. In addition, by bringing the vehicle to a standstill between correction movements, sensing accuracy performance is increased, as any errors that are caused or exacerbated by vehicle movement are eliminated. In addition, all errors due to processing time may be eliminated. This improves overall hitch assist system alignment, as the vehicle tracks more precisely to the target location.

According to various examples, a hitch assist system is provided herein. The hitch assist system includes a sensing system configured to detect a hitch assembly and a coupler. A controller is configured to generate commands for maneuvering the vehicle along a positioning path and a subsequent alignment path. The alignment path has one or more sequential corrections such that the hitch assembly is aligned with the coupler upon completion of the alignment path. Examples of the hitch assist system can include any one or a combination of the following features:
the vehicle is stopped between the positioning path and the alignment path;
the sensing system includes one or more imagers;
the imager is located on a rear of a vehicle and is disposed to capture one or more images of a rear-vehicle scene;
an offset distance between the hitch assembly and the coupler is determined while the vehicle is stopped;
a steering angle is fixed during each of the one or more corrections;
the positioning path terminates at an initial endpoint and the alignment path terminates at a final endpoint, the initial endpoint offset from the final endpoint;
the vehicle road wheels rotate less than about one full rotation during each of the one or more corrections;
the controller determines a new alignment path between each of the one or more corrections; and/or
the hitch assembly comprises a hitch ball and the coupler comprises a coupler ball socket.

Moreover, a method of correcting misalignment between a vehicle hitch assembly and a coupler is provided herein. The method includes determining an offset of a hitch ball relative to said coupler. The method also includes calculating a first segment along an alignment path to align the hitch ball to said coupler. The method further includes maintaining a first constant steering angle. The method also includes maneuvering the vehicle a predefined distance along the first segment and stopping the vehicle. Lastly, the method includes recalculating the offset of the hitch ball relative to said coupler. Examples of the method can include any one or a combination of the following features:
calculating a second segment along an alignment path to align the hitch ball to said coupler; maintaining a second constant steering angle; maneuvering the vehicle a predefined distance along the second segment; stopping the vehicle; and recalculating the offset of the hitch ball relative to said coupler;
maintaining the vehicle in a substantially fixed position once the hitch ball is aligned with said coupler;
the predefined distance along the first segment step is less than the offset distance between the hitch ball and said coupler;
the predefined distance is based on a scheduled brake pattern; and/or
the calculating a first segment along an alignment path to align the hitch ball to said coupler step further includes predicting a distance between the hitch ball and said coupler upon completion of the maneuvering of the vehicle.

According to some examples, a hitch assist system is provided herein. The hitch assist system includes a sensing system configured to detect a hitch assembly and a coupler. A controller is configured to generate commands for maneuvering the vehicle along a positioning path and a subsequent alignment path. The alignment path has one or more sequential corrections. A brake control system is configured to stop the vehicle between the positioning path and the subsequent alignment path. Examples of the hitch assist system can include any one or a combination of the following features:
an offset distance between the hitch assembly and the coupler is determined while the vehicle is stopped and between the positioning path and the alignment path;
a steering angle is fixed during each of the one or more corrections and/or
the vehicle road wheels rotate less than about one full rotation during each of the one or more corrections.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

Implementations of the systems, apparatuses, devices, and methods disclosed herein may include or utilize a special-purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general-purpose or special-purpose computer system. Computer-readable media that store computer-executable instructions are computer storage media (devices). Computer-readable media that carry computer-executable instructions are transmission media. Thus, by way of example, and not limitation, implementations of the present disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general-purpose or special-purpose computer. Combinations of the above should also be included within the scope of computer-readable media.

Computer-executable instructions include, for example, instructions and data, which, when executed at a processor, cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through the network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It will be noted that the sensor examples discussed above might include computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Examples of the present disclosure may be implemented in further types of devices, as would be known to persons skilled in the relevant art(s).

At least some examples of the present disclosure have been directed to computer program products including such logic (e.g., in the form of software) stored on any computer usable medium. Such software, when executed in one or more data processing devices, causes a device to operate as described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It will be noted that the elements and/or assemblies of the system might be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A hitch assist system comprising:
a sensing system configured to detect a hitch assembly and a coupler; and
a controller configured to generate commands for maneuvering the vehicle along a positioning path and a subsequent alignment path, the alignment path having one or more sequential corrections such that the hitch assembly is aligned with the coupler upon completion of the alignment path.

2. The hitch assist system of claim 1, wherein the vehicle is stopped between the positioning path and the alignment path.

3. The hitch assist system of claim 2, wherein the sensing system includes one or more imagers.

4. The hitch assist system of claim 3, wherein the imager is located on a rear of a vehicle and is disposed to capture one or more images of a rear-vehicle scene.

5. The hitch assist system of claim 2, wherein an offset distance between the hitch assembly and the coupler is determined while the vehicle is stopped.

6. The hitch assist system of claim 1, wherein a steering angle is fixed during each of the one or more corrections.

7. The hitch assist system of claim 1, wherein the positioning path terminates at an initial endpoint and the alignment path terminates at a final endpoint, the initial endpoint offset from the final endpoint.

8. The hitch assist system of claim 1, wherein the vehicle road wheels rotate less than about one full rotation during each of the one or more corrections.

9. The hitch assist system of claim 1, wherein the controller determines a new alignment path between each of the one or more corrections.

10. The hitch assist system of claim 1, wherein the hitch assembly comprises a hitch ball and the coupler comprises a coupler ball socket.

11. A method of correcting misalignment between a vehicle hitch assembly and a coupler, comprising the steps of:
determining an offset of a hitch ball relative to said coupler;
calculating a first segment along an alignment path to align the hitch ball to said coupler;
maintaining a first constant steering angle;
maneuvering the vehicle a predefined distance along the first segment;
stopping the vehicle; and
recalculating the offset of the hitch ball relative to said coupler.

12. The hitch assist method of claim 11, further comprising:
calculating a second segment along an alignment path to align the hitch ball to said coupler;
maintaining a second constant steering angle;
maneuvering the vehicle a predefined distance along the second segment;
stopping the vehicle; and
recalculating the offset of the hitch ball relative to said coupler.

13. The hitch assist method of claim 12, further comprising:
maintaining the vehicle in a substantially fixed position once the hitch ball is aligned with said coupler.

14. The hitch assist method of claim 11, wherein the predefined distance along the first segment step is less than the offset distance between the hitch ball and said coupler.

15. The hitch assist method of claim 11, wherein the predefined distance is based on a scheduled brake pattern.

16. The hitch assist method of claim 12, wherein the calculating a first segment along an alignment path to align the hitch ball to said coupler step further includes predicting a distance between the hitch ball and said coupler upon completion of the maneuvering of the vehicle.

17. A hitch assist system comprising:
a sensing system configured to detect a hitch assembly and a coupler;
a controller configured to generate commands for maneuvering the vehicle along a positioning path and a subsequent alignment path, the alignment path having one or more sequential corrections; and
a brake control system configured to stop the vehicle between the positioning path and the subsequent alignment path.

18. The hitch assist system of claim 17, wherein an offset distance between the hitch assembly and the coupler is determined while the vehicle is stopped and between the positioning path and the alignment path.

19. The hitch assist system of claim 17, wherein a steering angle is fixed during each of the one or more corrections.

20. The hitch assist system of claim 17, wherein the vehicle road wheels rotate less than about one full rotation during each of the one or more corrections.
